(19) United States
(12) Patent Application Publication
(10) Pub. No.: US 2026/0052493 A1
(43) Pub. Date: Feb. 19, 2026

(54) DEVICE-CHARACTERISTIC-BASED SYNCHRONIZATION MANAGEMENT FOR D2D DEVICES

(71) Applicant: Telefonaktiebolaget LM Ericsson (publ), Stockholm (SE)

(72) Inventors: Jose Angel LEON CALVO, Aachen (DE); Bikramjit SINGH, Raasepori (FI); Majid GERAMI, Lund (SE)

(73) Assignee: Telefonaktiebolaget LM Ericsson (publ), Stockholm (SE)

(21) Appl. No.: 19/103,233

(22) PCT Filed: Sep. 12, 2022
(86) PCT No.: PCT/EP2022/075309

§ 371 Date: Feb. 12, 2025

(51) Int. Cl. H04W 56/00; H04W 8/22

(52) U.S. Cl. CPC H04W 56/0015; H04W 8/22; H04W 56/003

(57) ABSTRACT

A device-to-device, D2D, communication device (10) receives a first synchronization signal from a first other D2D communication device (10) and receives a second synchronization signal from a second other D2D communication device (10). If the first other D2D communication device (10) and the second other D2D communication device (10) have the same priority level for selection as a synchronization reference, the D2D communication device (10) compares a characteristic of the first other D2D communication device (10) to a characteristic of the second other D2D communication device (10). Based on the comparison, the D2D communication device (10) selects between synchronizing to the first synchronization signal and synchronizing to the second synchronization signal.

### TECHNICAL FIELD

The present invention relates to methods for controlling device-to-device (D2D) communication and to corresponding devices, systems, and computer programs.

### BACKGROUND

Current wireless communication networks, e.g., based on the 4G (4th Generation) LTE (Long Term Evolution) or 5G (5th Generation) NR technology as specified by 3GPP (3rd Generation Partnership Project), also support D2D communication modes to enable direct communication between UEs (user equipments), sometimes also referred to as sidelink communication. Such D2D communication modes may for example be used for vehicle communications, e.g., including communication between vehicles, between vehicles and roadside communication infrastructure and, possibly, between vehicles and cellular networks. Due to wide range of different types of devices that might be involved in the communication with the vehicles, vehicle-to-everything (V2X) communication is another term used to refer to this class of communication. Vehicle communications have the potential to increase traffic safety, reduce energy consumption and enable new services related to intelligent transportation systems.

Due to the nature of the basic road safety services, LTE V2X functionalities have been designed for broadcast transmissions, i.e., for transmissions where all receivers within a certain range of a transmitter may receive a message from the transmitter, i.e., may be regarded as intended recipients. In fact, the transmitter may not be aware or otherwise be able to control the group of intended receivers. V2X functionalities for the NR technology are for example described in 3GPP TR 38.885 V16.0.0 (2019-03). In the NR technology, also more targeted V2X services are considered, by supporting also groupcast, multicast, or unicast transmissions, in which the intended receiver of a message consists of only a subset of the receivers within a certain range of the transmitter (groupcast) or of a single receiver (unicast). For example, in a platooning service for vehicles there may be certain messages that are only of interest for a member vehicle of the platoon, so that the member vehicles of the platoon can be efficiently targeted by a groupcast transmission. In another example, the see-through functionality, where a one vehicle provides video data from a front facing camera to a following vehicle, may involve V2X communication of only a pair of vehicles, for which unicast transmissions may be a preferred choice. Furthermore, NR sidelink communication supports D2D communication of UEs with and without network coverage, with varying degrees of interaction between the UEs and the network, including the possibility of standalone, network-less operation.

In D2D communication, synchronization of UEs may be used for establishing D2D communication or for enhancing performance of D2D communication. The synchronization typically involves providing synchronization information to a UE. For example, in a sidelink discovery procedure of the LTE technology, the synchronization information may include a Sidelink Synchronization Signal (SLSS), timing information, and/or some additional configuration parameters, e.g., a MasterInformationBlock-SL message or MasterInformationBlock-SL-V2X message. In the NR technology the synchronization information may include an Sidelink Synchronization Signal Block (S-SSB). The synchronization information transmitted by the UE may be derived from information or signals received from the network while in coverage, received from a UE acting as a synchronization reference for the transmitting UE, or received from a global navigation satellite system (GNSS). The S-SSB includes Sidelink synchronization signals (SLSS) and a physical sidelink broadcast channel (PSBCH). The SLSS are synchronization sequences that depend on a SLSS identity (SLSSID). The S-SSB is transmitted in a slot and spans 7 to 14 Orthogonal Frequency Division Multiplexing (OFDM) symbols, including a last OFDM symbol that is not used, and which constitutes a Guard Period (GP). The S-SSB is transmitted periodically according to an S-SSB period, e.g., every 160 ms. It may be transmitted one or multiple times within a period, i.e., there may be S-SSB repetitions. An SLSS identifier (SLSS-ID) indicated by the SLSS, in some cases together with the contents of PSBCH, provides an indication of priority associated with the S-SSB. In the absence of an external, more reliably source of synchronization, e.g., GNSS-derived or NW-derived synchronization, a UE typically searches for the S-SSB transmission indicating highest priority and synchronizes to it.

Typically, a UE is configured with two resources where S-SSB may be transmitted. It typically transmits on one and listens to the other one. In this way it can transmit and receive S-SSB signals within one period, e.g., of 160 ms. Among the two resources, which one to use for transmission is determined based on the synchronization status of the transmitting UE, such as priority value of the used synchronization reference, and some (pre-) configured parameters. Reception of S-SSB is attempted in the other resource. The SLSS-ID used for transmission is typically different from the one(s) a UE may expect to receive. In some cases, three resource may be configured, the third one being used by UEs deriving synchronization directly from GNSS.

With respect to its functionality as a transmitter of the S-SSB, a UE may be configured to transmit the S-SSB in one of the two resources one or a (pre-) configured number of times per period, e.g., of 160 ms, using a value of SLSS-ID and contents of the PSBCH that are determined based on the synchronization status of the UE. As regards reception of the S-SSB by a UE, the purpose of receiving the S-SSB is to determine the synchronization reference used by other UEs in their transmission. Depending on the priorities of the synchronization reference used by the receiving UE and of the synchronization reference indicated by the received S-SSB and depending on a measurement of the received power of the received S-SSB, the receiving UE decides whether to keep its current synchronization reference or to switch to the new reference indicated by S-SSB. As explained earlier, a change of synchronization reference in turn affects the behavior of the UE as a transmitter of S-SSB. For example, it determines the values of SLSS-ID and the contents of PSBCH to be used for transmission of S-SSB.

A distributed protocol is used to ensure that different UEs using the same synchronization reference transmit S-SSB at the same time with exactly the same contents, including SLSS-ID and PSBCH contents. Thus, a receiver typically observes a linear superposition of the signals transmitted from multiple UEs. This is sometimes referred to as receiving an SFN combination of signals.

If LTE procedure is followed, once there are two synchronization references with the same priority there is no standard procedure to decide which one prevails. A solution created for LTE was that each UE can track multiple synchronization references, and therefore, is able to be synchronized with several UEs with different synchronization references at the same time. However, the problem of this solution is the scalability and the increase on UE complexity and cost, to obtain it. Therefore, in the case of a pair of UEs without any other synchronization reference than their internal clock, there is no mechanism to achieve synchronization consensus. As a result, each UE would keep its own synchronization reference. The situation similar in the case of NR SL when considering of out-of-coverage UEs, i.e., UEs which are not under the coverage of an eNB/gNB or GNSS. FIG. 1 illustrates a table showing the existing synchronization priority classification of NR SL Rel-16. As can be seen, in an out-of coverage scenario of multiple UEs, there will be no unified synchronization reference for the UEs, because every UE will use a synchronization reference of same priority (P6 or P6′), so that none of the UEs will switch to another synchronization reference. FIG. 2 illustrates a corresponding example, where a group of UEs with T2 synchronization references cannot communicate with the other group of UEs with T1 synchronization reference.

Accordingly, there is a need for techniques which allow for selection of a synchronization reference for D2D communication.

### SUMMARY

According to an embodiment, a method of controlling D2D communication is provided. According to the method, a D2D communication device receives a first synchronization signal from a first other D2D communication device. Further, the D2D communication device receives a second synchronization signal from a second other D2D communication device. If the first other D2D communication device and the second other D2D communication device have the same priority level for selection as a synchronization reference, the D2D communication device compares a characteristic of the first other D2D communication device to a characteristic of the second other D2D communication device. Based on the comparison, the D2D communication device selects between synchronizing to the first synchronization signal and synchronizing to the second synchronization signal.

According to a further embodiment, a method of controlling D2D communication is provided. According to the method, a D2D communication device transmits a synchronization signal for enabling synchronization of one or more further D2D communication devices using the D2D communication device as a synchronization reference. Further, the D2D communication device indicates a characteristic of the D2D communication device to the one or more further D2D communication devices.

According to a further embodiment, a D2D communication device is provided. The D2D communication device is configured to receive a first synchronization signal from a first other D2D communication device. Further, the D2D communication device is configured to receive a second synchronization signal from a second other D2D communication device. Further, the D2D communication device is configured to, if the first other D2D communication device and the second other D2D communication device have the same priority level for selection as a synchronization reference, compare a characteristic of the first other D2D communication device to a characteristic of the second other D2D communication device and, based on the comparison, select between synchronizing to the first synchronization signal and synchronizing to the second synchronization signal.

According to a further embodiment, a D2D communication device is provided. The D2D communication device comprises at least one processor and a memory. The memory contains instructions executable by said at least one processor, whereby the D2D communication device is operative to receive a first synchronization signal from a first other D2D communication device. Further, the memory contains instructions executable by said at least one processor, whereby the D2D communication device is operative to receive a second synchronization signal from a second other D2D communication device. Further, the memory contains instructions executable by said at least one processor, whereby the D2D communication device is operative to, if the first other D2D communication device and the second other D2D communication device have the same priority level for selection as a synchronization reference, compare a characteristic of the first other D2D communication device to a characteristic of the second other D2D communication device and, based on the comparison, select between synchronizing to the first synchronization signal and synchronizing to the second synchronization signal.

According to a further embodiment, a D2D communication device is provided. The D2D communication device is configured to transmit a synchronization signal for enabling synchronization of one or more further D2D communication devices using the D2D communication device as a synchronization reference. Further, the D2D communication device is configured to indicate a characteristic of the D2D communication device to the one or more further D2D communication devices.

According to a further embodiment, a D2D communication device is provided. The D2D communication device comprises at least one processor and a memory. The memory contains instructions executable by said at least one processor, whereby the D2D communication device is operative to transmit a synchronization signal for enabling synchronization of one or more further D2D communication devices using the D2D communication device as a synchronization reference. Further, the memory contains instructions executable by said at least one processor, whereby the D2D communication device is operative to indicate a characteristic of the D2D communication device to the one or more further D2D communication devices.

According to a further embodiment of the invention, a computer program or computer program product is provided, e.g., in the form of a non-transitory storage medium, which comprises program code to be executed by at least one processor of a D2D communication device. Execution of the program code causes the D2D communication device to receive a first synchronization signal from a first other D2D communication device. Further, execution of the program code causes the D2D communication device to receive a second synchronization signal from a second other D2D communication device. Further, execution of the program code causes the D2D communication device to, if the first other D2D communication device and the second other D2D communication device have the same priority level for selection as a synchronization reference, compare a characteristic of the first other D2D communication device to a characteristic of the second other D2D communication device and, based on the comparison, select between synchronizing to the first synchronization signal and synchronizing to the second synchronization signal.

According to a further embodiment of the invention, a computer program or computer program product is provided, e.g., in the form of a non-transitory storage medium, which comprises program code to be executed by at least one processor of a D2D communication device. Execution of the program code causes the D2D communication device to transmit a synchronization signal for enabling synchronization of one or more further D2D communication devices using the D2D communication device as a synchronization reference. Further, execution of the program code causes the D2D communication device to indicate a characteristic of the D2D communication device to the one or more further D2D communication devices.

Details of such embodiments and further embodiments will be apparent from the following detailed description of embodiments.

### BRIEF DESCRIPTION OF THE DRAWINGS

FIG. 1 schematically illustrates a priority order of synchronization references for D2D communication devices.

FIG. 2 schematically illustrates an example of a scenario where multiple synchronization references of the same priority are present and cause non-unitary selection of synchronization references.

FIG. 3 schematically illustrates an exemplary V2X scenario in which D2D communication may be controlled according to an embodiment of the invention.

FIG. 4 schematically illustrates an exemplary scenario according to an embodiment of the invention, in which D2D communication may be controlled according to an embodiment of the invention.

FIG. 5 schematically illustrates a priority order of synchronization references for D2D communication devices according to an embodiment of the invention.

FIG. 6 schematically illustrates an exemplary scenario according to an embodiment of the invention, in which D2D communication devices select their synchronization reference according to an embodiment of the invention.

FIG. 7 shows a flowchart for schematically illustrating a method according to an embodiment of the invention.

FIG. 8 shows a flowchart for schematically illustrating a method according to an embodiment of the invention.

FIG. 9 schematically illustrates structures of a D2D communication device according to an embodiment of the invention.

### DETAILED DESCRIPTION OF EMBODIMENTS

In the following, concepts in accordance with exemplary embodiments of the invention will be explained in more detail and with reference to the accompanying drawings. The illustrated embodiments relate to controlling of D2D communication by wireless communication devices. These wireless communication devices may include various types of UEs or other wireless devices (WDs). As used herein, the term “wireless device” (WD) refers to a device capable, configured, arranged, and/or operable to communicate wirelessly with network nodes and/or other WDs. Unless otherwise noted, the term WD may be used interchangeably herein with UE. Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a Voice over IP (VOIP) phone, a wireless local loop phone, a desktop computer, a Personal Digital Assistant (PDA), a wireless camera, a gaming console or device, a music storage device, a playback appliance, a wearable terminal device, a wireless endpoint, a mobile station, a tablet, a laptop, Laptop Embedded Equipment (LEE), Laptop Mounted Equipment (LME), a smart device, a wireless Customer Premise Equipment (CPE), a vehicle mounted wireless terminal device, a connected vehicle, etc. In some examples, in an Internet of Things (IoT) scenario, a WD may also represent a machine or other device that performs monitoring and/or measurements, and transmits the results of such monitoring and/or measurements to another WD and/or a network node. The WD may in this case be a Machine-to-Machine (M2M) device, which may in a 3GPP context be referred to as a Machine-Type Communication (MTC) device. As one particular example, the WD may be a UE implementing the 3GPP Narrowband IoT (NB-IoT) standard. Particular examples of such machines or devices are sensors, metering devices such as power meters, industrial machinery, home or personal appliances (e.g., refrigerators, televisions, etc.), or personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal. The illustrated concepts particularly concern WDs that support D2D communication, for example by implementing a 3GPP standard for sidelink communication, Vehicle-to-Vehicle (V2V), Vehicle-to-Infrastructure (V21), Vehicle-to-Everything (V2X). The WDs supporting D2D communication are herein also referred to as D2D communication devices. The D2D communication may for example be based on the LTE radio technology or the NR radio technology as specified by 3GPP, e.g., on the PC5 SL interface of the LTE or NR technology. However, it is noted that the illustrated concepts could also be applied to other radio technologies, e.g., a WLAN (Wireless Local Area Network) technology.

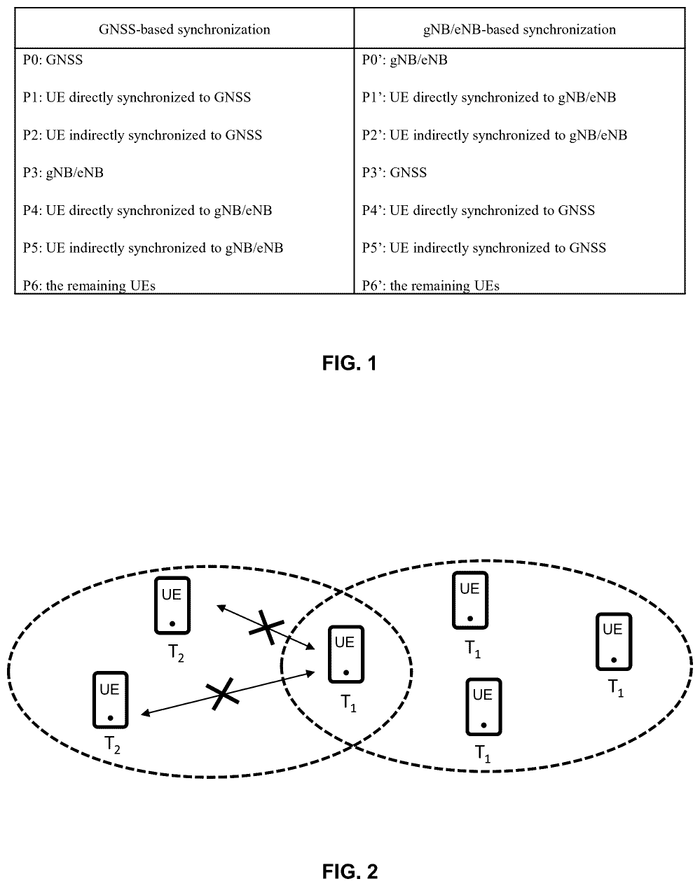

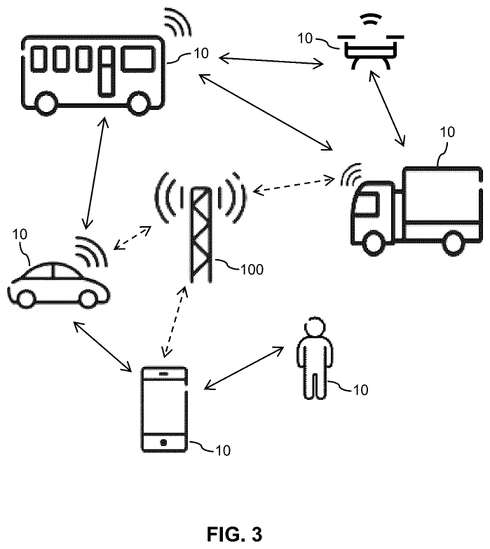

In the illustrated concepts, one or more characteristics of a D2D communication device are considered when deciding whether to select the D2D communication device as a synchronization reference. Specifically, in a situation where a certain D2D communication device receives a first synchronization signal from a first other D2D communication devices and a second synchronization signal from a second other D2D communication device, and the first and second other D2D communication devices have the same priority for selection as a synchronization reference, e.g., because they both correspond to P6 or P6′ in the priority order of FIG. 1, the D2D communication device will base the decision whether to synchronize to the first other D2D communication device or to the second other D2D communication device on at least one characteristic of the first other D2D communication device and the second other D2D communication device. The D2D communication devices may correspond to various types of UE, and the synchronization signals may correspond to S-SSBs of the NR technology. Various kinds of characteristics of the D2D communication devices may be considered, such as a quality of an internal clock of the D2D communication device, a device type of the D2D communication device, a capability of the D2D communication device, resources available to the D2D communication device, a number of further D2D communication devices using the D2D communication device as synchronization reference, or the like. In some cases, such characteristics may be fixed, such as the device type or quality of the internal clock. In other cases, such characteristics may be variable, such as the number of further synchronized D2D communication devices using the D2D communication device as synchronization reference. It is however noted that the characteristics of the D2D communication device may not be confused with characteristics of the synchronization signal as received from the D2D communication device, such as received power or received signal quality.

In the illustrated concepts, synchronization consensus may be achieved for UEs which are out of coverage or influence of a GNSS, eNB, gNB, so that no other synchronization sources except the UEs' internal clocks are available. The synchronization consensus means that the UEs in a certain area will eventually select the same UE as synchronization reference, or that at least the number of utilized synchronization references in the area is reduced. The selection scheme of the illustrated concepts may converge to a stable situation while using a one-hop information. For example, when basing the selection of the synchronization references on the quality of the internal clock of the UEs, the UE(s) with the best quality of the internal clock will be selected as the common synchronization reference for all UEs in a certain area. The information of the characteristics may be shared among the UEs, e.g., by including it into information conveyed by the transmitted synchronization signals. Defining additional priority levels for synchronization reference selection is not needed. The illustrated concepts may also be applied in scenarios when there are two or more groups of UEs, each using a different synchronization reference of the same priority, to achieve that at least some of the groups select the same synchronization reference.

As mentioned above, the illustrated concepts may be applied to synchronization of D2D communication devices in out-of-coverage scenarios, e.g., UEs which are outside coverage of a 4G network, a 5G network or future 6G network. Further, the illustrated concepts could also be applied to D2D communication devices which do not support cellular network connectivity or synchronization to a GNSS or in scenarios where the cellular network connectivity and/or GNSS connection is lost or unreliable, e.g., when considering vehicular communications or public safety applications in tunnels or inside of buildings. A further scenario where synchronization of D2D communication devices based on the illustrated concepts may be beneficial is applications involving a swarm of devices, e.g., a swarm of drones or autonomous sensors. For such devices, synchronization to a GNSS or cellular network could be restricted or unavailable due to environmental conditions or capability of the devices. Further scenarios where synchronization to a GNSS or cellular network could be restricted or unavailable included operation of D2D communication devices at high altitude or high mobility of the D2D communication devices.

FIG. 3 illustrates an exemplary scenario involving V2X communications. In particular, FIG. 3 shows various UEs 10, which may engage in V2X communication or other D2D communication, illustrated by solid arrows. Further, FIG. 3 shows an access node 100 of a wireless communication network, e.g., an eNB of the LTE technology or a gNB of the NR technology, or an access point of a WLAN. At least some of the UEs 10 may also be capable of communicating by using DL radio transmissions and/or UL radio transmissions, illustrated by broken arrows.

The UEs 10 illustrated in FIG. 3 comprise vehicles, a drone, a mobile phone, and a person, e.g., a pedestrian, a cyclist, a driver of a vehicle, or a passenger of a vehicle. Here, it is noted that in the case of the vehicles the radio transmissions may be performed by a communication module installed in the vehicle, and that in the case of the person the radio transmissions may be performed by a radio device carried or worn by the person, e.g., a wristband device or similar wearable device. Furthermore, it is noted that the UEs shown in FIG. 3 are merely exemplary and that in the illustrated concepts other types of V2X communication device or D2D communication device could be utilized as well, e.g., RSUs (roadside units) or other infrastructure based V2X communication devices, V2X communication devices based in an aircraft, like an airplane, or helicopter, in a spacecraft, in a train or car of a train, in a ship, in a motorcycles, in a bicycle, in a mobility scooter, or in any other kind of mobility or transportation device. The V2X communication may also involve utilizing the illustrated mechanisms and procedures to enable DRX operation for the V2X communication between the UEs 10, thereby improving energy efficiency of the V2X communication.

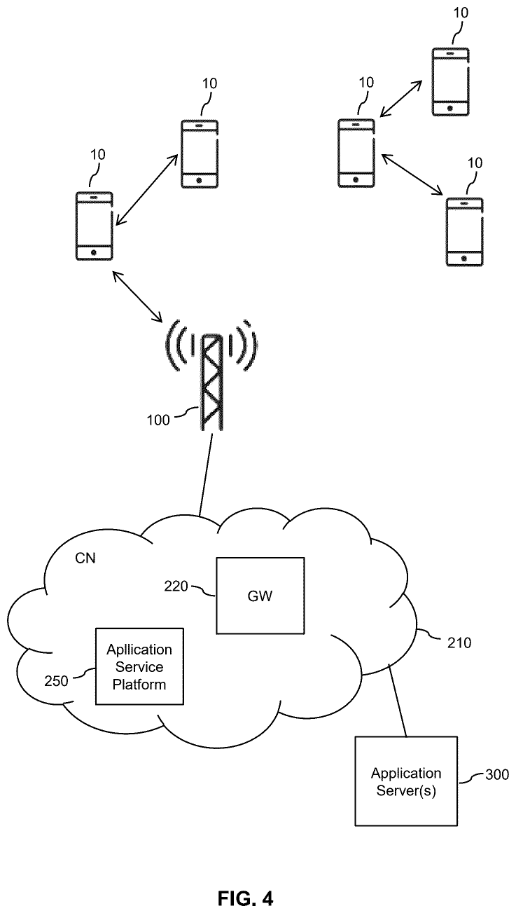

FIG. 4 illustrates an exemplary D2D communication scenario. In particular, FIG. 4 shows multiple UEs 10, which are connected to each other by radio links implementing direct wireless links (illustrated by double-headed arrows). Further, one of the UEs 10 is connected by a radio link to an access node 100 of a wireless communication network, e.g., to an eNB of the LTE technology, or a gNB of the NR technology. The access node 100 is part of a RAN (Radio Access Network) of the wireless communication network, which typically also includes further access nodes to provide a desired coverage of the wireless communication network. Further, FIG. 4 shows a core network (CN) 210 of the wireless communication network. The CN 210 may provide connectivity of the UEs 10 to other data networks, e.g., through a GW 220 provided in the CN 210. Further, the CN 210 may also include various nodes for controlling operation of the UEs 10.

The radio links may be used for D2D communication between the UEs 10. Further, the radio link to the wireless communication network may be used for controlling or otherwise assisting the D2D communication. Further, the D2D communication and/or data communication with the wireless communication network may be used for providing various kinds of services to the UEs 10, e.g., a voice service, a multimedia service, a data service, an intelligent transportation system (ITS) or similar vehicular management or coordination service, an NSPS service, and/or an NCIS service. Such services may be based on applications which are executed on the UE 10 and/or on a device linked to the UE 10. Accordingly, in the illustrated concepts a D2D transmission may convey or correspond to a V2X message, an ITS message, or some other kind of message related to a service. Further, FIG. 4 illustrates an application service platform 250 in the CN 210 of the wireless communication network. Further, FIG. 4 illustrates one or more application servers 300 provided outside the wireless communication network. The application(s) executed on the UE 10 and/or on one or more other devices linked to the UE 10 may use the radio links with one or more other UEs 10, the application service platform 250, and/or the application server(s) 300, thereby enabling the corresponding service(s) on the UE 10. In some scenarios, the services utilized by the UEs 10 may thus be hosted on the network side, e.g., on the application service platform 250 or on the application server(s) 300. However, some of the services may also network-independent so that they can be utilized without requiring an active data connection to the wireless communication network. This may for example apply to certain V2X services or NSPS (National Security and Public Safety) services. Such services may be used in out-of-coverage situations, but could still be assisted from the network side while the UE 10 is in coverage of the wireless communication network, e.g., by configuring the UEs 10 with respect to the usage of the services. The application service platform 250 and the server(s) 300 may also be regarded as host computer which hosts a service provided by an application executed on the UE 10 and utilizes DL transmissions, UL transmissions, and/or D2D transmissions. Also in the scenario of FIG. 4, the UEs 10 may apply the DRX operation to the D2D communication to improve energy efficiency.

In the example of FIG. 4, the UEs 10 are assumed to be a mobile phone and vehicles or vehicle-based communication devices, e.g., a vehicle-mounted or vehicle-integrated communication module, or a smartphone or other user device linked to vehicle systems. However, it is noted that other types of UE could be used as well, e.g., a device carried by a pedestrian, or an infrastructure-based device, such as a roadside unit, like for example illustrated in FIG. 3.

As mentioned above, in the claimed solution one or more of the UEs 10 may use another one of the UEs 10 as synchronization reference, and the selection of this of this UE 10 acting as synchronization reference is based on one or more characteristics of the UEs 10, in the following also denoted as “device characteristics”. Accordingly, synchronization consensus can be enabled in scenarios where no synchronization sources of higher priority are available. It can be achieved that larger groups of UEs 10 select the same UE 10 as common synchronization source, so that formation of isolated synchronization clusters can be avoided. Further, such synchronization consensus can be achieved without requiring excessive signaling among the UEs 10.

In some scenarios, the characteristics considered in the selection of the UE 10 to be used as synchronization reference includes a quality of an internal clock of the UE 10, i.e., the internal clock from which the UE 10 will derive the synchronization signals it is transmitting. Accordingly, the synchronization consensus may be based on the quality of the respective internal clock of the UEs 10 in a certain area. The quality of the internal clock may for example be assessed in terms of clock stability, e.g., as represented by clock drift. In this way it can be achieved that, among multiple internal clocks the one with the best quality is selected as the common synchronization reference of the UEs 10. As a result, D2D transmissions between the UEs 10 can be better aligned, which helps to achieve higher performance. Synchronization to a high quality clock may also be beneficial in applications where a relative timing of multiple devices needs to be controlled in a deterministic manner, e.g., like in advanced Industrial Internet of Things (IIoT) applications.

The quality of the internal clock may for example be considered by configuring each UE 10 to include information about its own internal clock into the broadcasted synchronization signals, e.g., into the S-SSB by the UE 10. For example, such information could be included in the PSBCH. The information may for example included in an information field of a message conveyed by the PSBCH or in the SLSS. The UEs 10 may then autonomously select as synchronization reference the synchronization signals based on the indicated information on the internal clock, e.g., by selecting that UE 10 as synchronization reference where the information indicates the clock with the lowest frequency tolerance or a frequency drift parameter.

Accordingly, the UEs 10 may include information on their own internal clock in the transmitted synchronization signals. In some scenarios, the UE 10 may include such information in a selective manner into the transmitted synchronization signal, e.g., in response to detecting that no other synchronization source than the UEs 10 own internal clock is available. This may have the effect that the information on the internal clock will be transmitted once in the initial synchronization, e.g., when the UE 10 enters a certain area with other UEs 10. Further, the information may be transmitted in response to detecting that the UE 10 itself has the best internal clock in the area and thus becomes the predominant synchronization reference.

In addition or as an alternative to indicating the information on its own internal clock in the broadcasted synchronization signals, the UEs 10 could also exchange information on the internal clocks of the UEs 10 during connection establishment, e.g., in RRC (Radio Resource Control) signaling for setting up an SL connection between two UEs 10. The information could then for example indicate the UE 10 which, based on previously received information, has the best internal clock in the area, the information related embodiment, the different parameters about the synchronization references, e.g., the clock with the lowest frequency tolerance or drift parameter, are exchanged among the different UEs during the connection establishment procedure, e.g., RRC signaling.

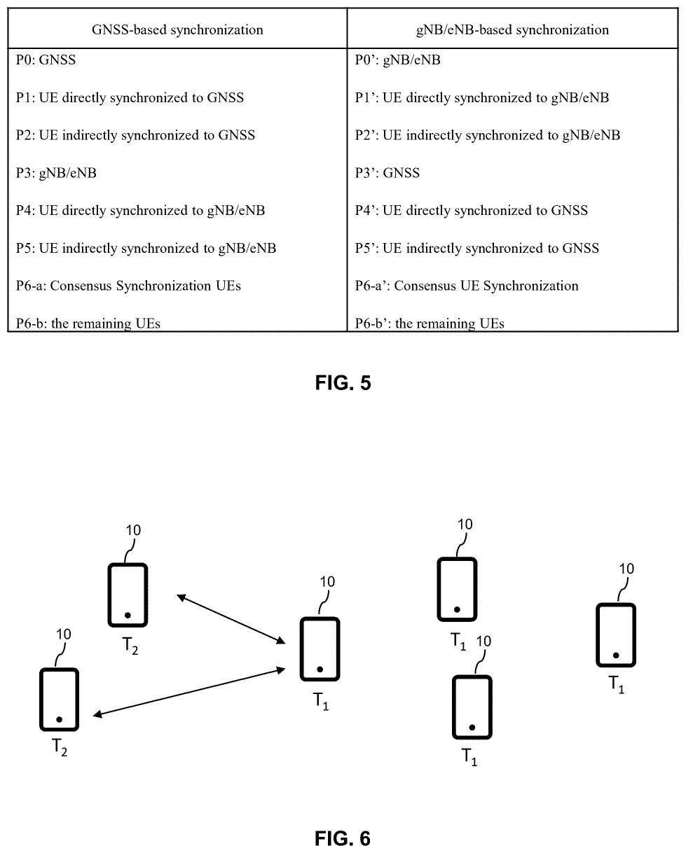

The above-described consensus-based selection of the synchronization reference may be integrated in existing schemes of prioritizing among different types of synchronization references. For example, the consensus-based selection may be applied with lower priority than the selection of synchronization references that are directly or indirectly derived from a GNSS or gNB/eNB. FIG. 5 shows a table which illustrates an example of such priority order. As can be seen, in the example of FIG. 5, the priority order corresponds to that of FIG. 1, i.e., to that as currently specified for the NR technology, adding the consensus-based selection in the GNSS-based synchronization as new priority level P6a below the UE indirectly synchronized to gNB/eNB (P5) and in the gNB/eNB based synchronization as new priority level P6-a′ below the UE indirectly synchronized to GNSS. The lowest priority level (P6-b, P6-b′) is given to any other UEs, i.e., to the UEs which are not synchronized to GNSS or gNB/eNB and which do not use the consensus-based synchronization.

As mentioned above, the information on the UEs' 10 internal clock may be indicated explicitly by including it into signaling transmitted by the UEs 10. Alternatively or in addition, such information could also be indicated in an implicit manner. Specifically, the information about each UE's 10 internal clock could be indicated based on UE identifiers (UE-IDs). For example, the UEs 10 could be provided with configuration information which maps the UE-IDs to different levels of internal clock quality, e.g., by defining that a sub-set of UE-IDs is known to have an accurate clock quality. Such configuration could be provided from the wireless communication network while the UEs 10 are in coverage or could be pre-configured in the UEs 10, e.g., based on manufacturer or operator settings. In some scenarios, the UE-ID used to indicate the internal clock quality could also be a UE-ID which is dedicated for synchronization purposes and is associated with a certain level of the internal clock quality.

In some scenarios, the information on the UE's 10 internal clock quality could also be included in discovery signaling. Specifically, for discovering other UEs 10 which are potential peers for D2D communication, the UEs 10 may send discover messages. Such discovery messages are for example specified for the SL discovery procedures of the NR technology and the LTE technology. Such discovery message may be supplemented by the information on the internal clock quality. The process of consensus-based synchronization could then for example be initiated when there is UE to network (UE2NW) relaying or UE-to-UE (UE2UE) relaying. In the discovery procedure, a handshake for achieving the consensus-based synchronization may be performed.

Another device characteristic which may be considered as an alternative or in addition to the internal clock quality is a number of existing synchronizations for the UE 10. For example, for a first UE 10, there could already be a high number of other UEs 10 using the first UE 10 as synchronization reference, while for second UE 10 the number of other UEs 10 using the second UE 10 as synchronization reference is lower. When a further UE 10 needs to select between using the first UE 10 and the second UE 10 as synchronization reference, it may be preferable to select the first UE 10 because it has a majority of other synchronized UEs 10. This may reduce the number of re-synchronizations needed to achieve synchronization consensus and speed up the process of convergency to a common synchronization reference for all UEs 10 in the considered area. This kind of selection may also be denoted as synchronization consensus based on synchronization majority.

As mentioned above, in the case of the synchronization consensus based on synchronization majority, the selection of the synchronization reference is based on a majority value related to the respective UE 10. The majority value of a given UE 10 may correspond to the number of other UEs 10 which use this UE 10 as synchronization reference. However, other kinds of majority value could also be used, e.g., the number of other UEs 10 using the same synchronization source as the considered UE 10.

In some scenarios, the UE 10 which needs to select a synchronization source may also determine the majority values needed for the selection. For example, if during one period the UE 10 receives multiple synchronization signals derived from the same synchronization reference, the UE 10 may select a synchronization signal that corresponds to the synchronization reference which is used by the highest number of peers UEs 10.

In some scenarios, an indication of the number of UEs 10 using the same synchronization reference could also be included in the received synchronization signals, e.g., in a field of the PSBCH or SLSS. For example, such field could include a parameter denoted as “number_of_synch” which indicates the number of other UEs 10 which use the same synchronization reference. The UE 10 receiving synchronization signals with such indication may then select that synchronization signal which indicates the higher value of the parameter “number_of_synch”. Each UE 10 may determine and store its own value of the parameter “number_of_synch” and indicate it to other UEs 10 if needed.

In a scenario assuming multiple UEs 10 which are out-of-coverage, each UE 10 using the predominant synchronization reference in the current period, which means that the UE did not change synchronization reference and the synchronization signals received by the UE 10 are either derived from the same synchronization reference or from a synchronization reference of lower priority, may determine the parameter “number_of_synch” by recording the number of synchronization signals received during one period and derived from the same synchronization reference as its own. The UE 10 may then include this parameter in its own transmitted synchronization signals, e.g., in the PSBCH or SLSS.

When considering a multi-hop scenario, a UE 10 could also calculate its parameter “number_of_synch” based on the values of this parameter as indicated in the synchronization signals received from other UEs 10. Specifically, the UE 10 may consider the values of this field for those received synchronization signals which are derived from the same synchronization reference, determine the maximum value, and increase the maximum value by one before forwarding this value as the parameter “number_of_synch” on the next hop.

In cases where a UE 10 receives more than one synchronization signal per period from the same other UE 10, the receiving UE 10 can check a field in the received synchronization signals which indicates a synchronization signal index, corresponding to the position of this synchronization signal within the current synchronization period. When determining its value of the parameter “number_of_synch”, the UE 10 may then discard the synchronization signals with an index higher than 1.

In some scenarios, a UE 10 could also select between indicating different values of the parameter “number_of_synch”. For example, such selection could depend on changes of the quality of device clock, due to variation of battery level or device temperature. By way of example, the UE 10 could indicate a lower value of the parameter “number_of_synch” if the battery level is low and a higher value of the parameter “number_of_synch” if the battery level is high. Similarly, the UE 10 could indicate a lower value of the parameter “number_of_synch” if the device temperature is high and a higher value of the parameter “number_of_synch” if the device temperature is low.

FIG. 6 illustrates an example where UEs 10 may select their synchronization sources based on a majority value as explained above. In the example of FIG. 6, a first group of UEs 10 use synchronization reference T1 and a second group of UEs 10 use synchronization reference T2. Due to having different synchronization references, D2D communication between the UEs 10 of different groups is typically not possible. In the above-described procedures, the UEs 10 of the first group transmit synchronization signals indicating a value of the parameter “number_of_synch”=4. The UEs 10 of the second group transmit synchronization signals indicating a value of the parameter “number_of_synch”=2. If a UE 10 of the second group receives a synchronization signal from a UE 10 of the first group, it will re-synchronize to this the synchronization signal received from the UE 10 of the first group. Further, it will spread this synchronization reference to the remaining UE 10 of the second group, with the value of the parameter “number_of_synch” being incremented by one. peer UEs incrementing the value of number_of_synch. As a result, the UEs 10 of the second group will change their synchronization reference to T1, so that there is a common synchronization reference for all UEs 10.

In some scenarios, the characteristic considered in the consensus-based selection of the synchronization reference may also be based on capabilities of the UEs 10. For example, in flexible topologies or mesh networks, there may be UEs 10 with different capabilities. For example, power saving devices, reduced capabilities (RedCap) devices, or vehicles, may be located in vicinity of each other and engage in D2D communication. In such scenarios, it may be beneficial to alternatively or additionally consider the device capabilities in the consensus-based selection of the synchronization reference.

Similar to the internal clock quality, the UEs 10 may explicitly include information on their capabilities in the transmitted synchronization signals. Alternatively or in addition, such information could also be included in other signaling, e.g., in a discovery message, in signaling performed during connection setup, e.g., RRC signaling, or in dedicated capability exchange signaling.

In some scenarios, power limited UEs 10 or RedCap UEs 10 may be configured to transmit their respective synchronization signals less frequently than other UEs 10. Such behavior may be configured from the wireless communication network or may be preconfigured, e.g., based on manufacturer of operator settings.

Further device characteristics that may be considered in the consensus-based selection of the synchronization reference may include transmission parameters of the above-mentioned signaling, in particular transmission parameters of the synchronization signals. Examples of such transmission parameters include:
Bandwidth or resource blocks available or actually used for transmission of the synchronization signals. If the bandwidth used to transmit the synchronization signals is smaller, the synchronization operation to be performed by other UEs 10 may be more challenging, so that it may be preferable to select a synchronization source transmitting the synchronization signal with higher bandwidth.
Signal sequence available or actually used for transmission of the synchronization signals.
Periodicity of the synchronization signals. For example, power limited UEs or RedCap UEs might transmit their synchronization signal less frequently.
Transmission power available or actually used for transmission of the synchronization signals. Power limited UEs or RedCap UEs might use less power to transmit synchronization their synchronization signals.

In some scenarios, when being are out-of-coverage of GNSS and eNB/gNB, the UEs 10 may be configured to apply a maximum periodicity for reception of the synchronization signaling. The maximum periodicity may be limited by device design, standardization, or manufacturer or operator settings. In this way, it can be achieved that the UE 10 will listen to or receive the maximum number of synchronization signals to which it could potentially synchronize, e.g., using the consensus-based selection of the synchronization reference. Further, the UEs 10 may be configured to be in full search mode for synchronization, i.e., they transmit their own synchronization signals according to the configured periodicity, and for the remaining period listen to the peer UEs' 10 synchronization signals.

In some scenarios, UEs 10 may move out of coverage of D2D communication or new UEs 10 may appear within coverage of D2D communication, e.g., due to mobility of the UEs 10. In the consensus-based selection of the synchronization reference, such disappearing or newly appearing UEs 10 may be considered based on a timer. The UEs 10 may maintain the obtained consensus-based synchronization for the duration of the timer. Upon expiry of the timer, the consensus-synchronization procedure may ne newly initiated so that an updated consensus-based synchronization can be obtained.

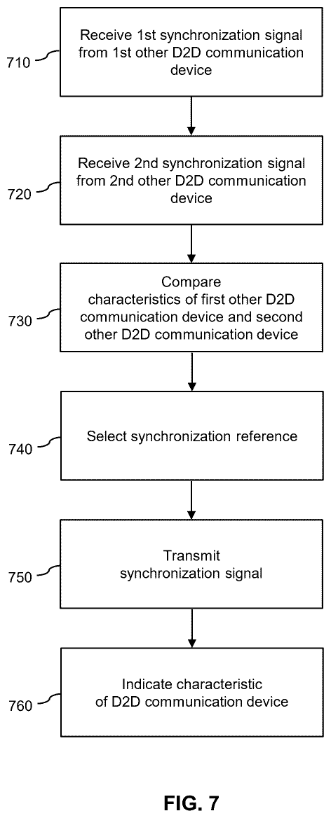

FIG. 7 shows a flowchart for illustrating a method, which may be utilized for implementing the illustrated concepts. The method of FIG. 7 may be used for implementing the illustrated concepts in a D2D communication device, e.g., corresponding to any of the above-mentioned UEs 10. In some scenarios, the D2D communication device may be a vehicle or vehicle-mounted device, but other types of WD, e.g., as mentioned above, could be used as well.

If a processor-based implementation of the D2D communication device is used, at least some of the steps of the method of FIG. 7 may be performed and/or controlled by one or more processors of the D2D communication device. Such D2D communication device may also include a memory storing program code for implementing at least some of the below described functionalities or steps of the method of FIG. 7.

At step 710, the D2D communication device receives a first synchronization signal from a first other D2D communication device, and at step 720, the D2D communication device receives a second synchronization signal from a second other D2D communication device.

At step 730, if the first other D2D communication device and the second other D2D communication device have the same priority level for selection as a synchronization reference, the D2D communication device compares a characteristic of the first other D2D communication device to a characteristic of the second other D2D communication device.

In some scenarios, the characteristic of the first other D2D communication device includes a quality of an internal clock of the first other D2D communication device and the characteristic of the second other D2D communication device includes a quality of an internal clock of the second other D2D communication device.

In some scenarios, the characteristic of the first other D2D communication device includes a frequency tolerance of the internal clock of the first other D2D communication device and the characteristic of the second other D2D communication device includes a frequency tolerance of the internal clock of the second other D2D communication device.

In some scenarios, the characteristic of the first other D2D communication device includes a frequency drift of the internal clock of the first other D2D communication device and the characteristic of the second other D2D communication device includes a frequency drift of the internal clock of the second other D2D communication device.

In some scenarios, the characteristic of the first other D2D communication device includes a number of D2D communication devices synchronized to the first other D2D communication device and the characteristic of the second other D2D communication device includes a number of D2D communication devices synchronized to the second other D2D communication device.

In some scenarios, the characteristic of the first other D2D communication device includes a number of D2D communication devices using the same synchronization reference as the first other D2D communication device and the characteristic of the second other D2D communication device includes a number of D2D communication devices using the same synchronization reference as the second other D2D communication device.

In some scenarios, the characteristic of the first other D2D communication device includes a type of the first other D2D communication device and the characteristic of the second other D2D communication device includes a type of the second other D2D communication device. Examples of such type of D2D communication device are: a vehicle, a sensor, a power-limited device, or a reduced capabilities device, a relay device, a roadside unit, an industrial device, or a wearable device.

In some scenarios, the characteristic of the first other D2D communication device includes a capability of the first other D2D communication device and the characteristic of the second other D2D communication device includes a capability of the second other D2D communication device.

In some scenarios, the characteristic of the first other D2D communication device includes a capability of the first other D2D communication device to transmit the first synchronization signal and the characteristic of the second other D2D communication device includes a capability of the second other D2D communication device to transmit the second synchronization signal.

In some scenarios, the characteristic of the first other D2D communication device includes a bandwidth available to the first other D2D communication device to transmit the first synchronization signal and the characteristic of the second other D2D communication device includes a bandwidth available to the second other D2D communication device to transmit the second synchronization signal.

In some scenarios, the characteristic of the first other D2D communication device includes radio resources available to the first other D2D communication device to transmit the first synchronization signal and the characteristic of the second other D2D communication device includes radio resources available to the second other D2D communication device to transmit the second synchronization signal.

In some scenarios, the characteristic of the first other D2D communication device includes a sequence type applicable by the first other D2D communication device to transmit the first synchronization signal and the characteristic of the second other D2D communication device includes a sequence type applicable by the second other D2D communication device to transmit the second synchronization signal.

In some scenarios, the characteristic of the first other D2D communication device includes a periodicity applicable by the first other D2D communication device to transmit the first synchronization signal and the characteristic of the second other D2D communication device includes a periodicity applicable by the second other D2D communication device to transmit the second synchronization signal.

In some scenarios, the characteristic of the first other D2D communication device includes a transmit power applicable by the first other D2D communication device to transmit the first synchronization signal and the characteristic of the second other D2D communication device includes a transmit power applicable by the second other D2D communication device to transmit the second synchronization signal.

In some scenarios, the first synchronization signal indicates the characteristic of the first other D2D communication device. Alternatively or in addition, the D2D communication device may receive further signaling from the first other D2D communication device and such further signaling may indicate the characteristic of the first other D2D communication device. The further signaling may for example include a discovery message or RRC signaling. The characteristic of the first other D2D communication device may be indicated as explicitly transmitted information or in an implicit manner. For example, the characteristic could be indicated by an identifier of the first other D2D communication device. In some scenarios, the D2D communication device may determine the characteristic of the first other D2D communication device based on an identifier of the first other D2D communication device, e.g., based on a mapping of the characteristic of the first other D2D communication device to the identifier of the first other D2D communication device. The identifier of the first other D2D communication device may include an identifier which is dedicated for synchronization purposes, and identifier which is also used for other purposes, or both.

In some scenarios, the second synchronization signal indicates the characteristic of the second other D2D communication device. Alternatively or in addition, the D2D communication device may receive further signaling from the second other D2D communication device and such further signaling may indicate the characteristic of the second other D2D communication device. The further signaling may for example include a discovery message or RRC signaling. The characteristic of the second other D2D communication device may be indicated as explicitly transmitted information or in an implicit manner. For example, the characteristic could be indicated by an identifier of the second other D2D communication device. In some scenarios, the D2D communication device may determine the characteristic of the second other D2D communication device based on an identifier of the second other D2D communication device, e.g., based on a mapping of the characteristic of the second other D2D communication device to the identifier of the second other D2D communication device. The identifier of the second other D2D communication device may include an identifier which is dedicated for synchronization purposes, and identifier which is also used for other purposes, or both.

At step 740, the D2D communication device selects between synchronizing to the first synchronization signal and synchronizing to the second synchronization signal. This selection is based on the comparison of step 730. Having synchronized to the selected one of the first synchronization signal or to the second synchronization signal, the D2D communication device may maintain the synchronization to the selected one of the first synchronization signal and the second synchronization signal until expiry of a timer.

At step 750, the D2D communication device may transmit a third synchronization signal for enabling synchronization of one or more further D2D communication devices using the D2D communication device as a synchronization reference. The third synchronization signal may for example include an S-SSB.

At step 760, the D2D communication device may indicate a characteristic of the D2D communication device to the one or more further D2D communication devices. In some scenarios, the third synchronization signal may indicate the characteristic of the D2D communication device. In some cases, the third synchronization signal may indicate the characteristic of the D2D communication device in only a subset of instances of periodic transmissions of the third synchronization signal. Alternatively or in addition, the D2D communication device could transmit further signaling indicating the characteristic of the D2D communication device, e.g., a discovery message or RRC signaling. The characteristic of the D2D communication device may be indicated as explicitly transmitted information or in an implicit manner. For example, the characteristic could be indicated by an identifier of the D2D communication device. The identifier of the D2D communication device may include an identifier which is dedicated for synchronization purposes, and identifier which is also used for other purposes, or both.

The characteristic of the D2D communication device may include a quality of an internal clock of the D2D communication device, e.g., a frequency tolerance of the internal clock of the D2D communication device and/or a frequency drift of the internal clock of the D2D communication device.

Alternatively or in addition, the characteristic of the D2D communication device may include a number of D2D communication devices synchronized to the D2D communication device. Alternatively or in addition, the characteristic of the D2D communication device may include a number of D2D communication devices using the same synchronization reference as the D2D communication device. Alternatively or in addition, the characteristic of the D2D communication device may include a type of the D2D communication device. Examples of such type of D2D communication device are: a vehicle, a sensor, a power-limited device, or a reduced capabilities device, a relay device, a roadside unit, an industrial device, or a wearable device. Alternatively or in addition, the characteristic of the D2D communication device may include a capability of the D2D communication device, e.g., a capability of the D2D communication device to transmit the third synchronization signal. Alternatively or in addition, the characteristic of the D2D communication device may include a bandwidth available to the D2D communication device to transmit the third synchronization signal. Alternatively or in addition, the characteristic of the D2D communication device may include radio resources available to the D2D communication device to transmit the third synchronization signal. Alternatively or in addition, the characteristic of the D2D communication device may include a sequence type applicable by the D2D communication device to transmit the third synchronization signal. Alternatively or in addition, the characteristic of the D2D communication device may include a periodicity applicable by the D2D communication device to transmit the third synchronization signal. Alternatively or in addition, the characteristic of the D2D communication device may include a transmit power applicable by the D2D communication device to transmit the third synchronization signal.

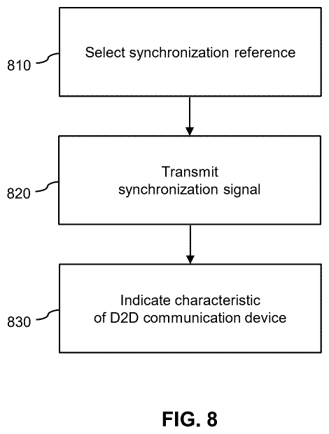

FIG. 8 shows a flowchart for illustrating a method, which may be utilized for implementing the illustrated concepts. The method of FIG. 8 may be used for implementing the illustrated concepts in a D2D communication device, e.g., corresponding to any of the above-mentioned UEs 10. In some scenarios, the D2D communication device may be a vehicle or vehicle-mounted device, but other types of WD, e.g., as mentioned above, could be used as well.

If a processor-based implementation of the D2D communication device is used, at least some of the steps of the method of FIG. 8 may be performed and/or controlled by one or more processors of the D2D communication device. Such D2D communication device may also include a memory storing program code for implementing at least some of the below described functionalities or steps of the method of FIG. 8.

At step 810, the D2D communication device may select a synchronization reference, e.g., its internal clock or another D2D communication device. Having synchronized to the synchronization reference, the D2D communication device may maintain the synchronization to the synchronization reference until expiry of a timer.

At step 820, the D2D communication device transmits a synchronization signal for enabling synchronization of one or more further D2D communication devices using the D2D communication device as a synchronization reference. The synchronization signal may for example include an S-SSB.

At step 830, the D2D communication device indicates a characteristic of the D2D communication device to the one or more further D2D communication devices. In some scenarios, the synchronization signal may indicate the characteristic of the D2D communication device. In some cases, the synchronization signal may indicate the characteristic of the D2D communication device in only a subset of instances of periodic transmissions of the third synchronization signal. Alternatively or in addition, the D2D communication device could transmit further signaling indicating the characteristic of the D2D communication device, e.g., a discovery message or RRC signaling. The characteristic of the D2D communication device may be indicated as explicitly transmitted information or in an implicit manner. For example, the characteristic could be indicated by an identifier of the D2D communication device. The identifier of the D2D communication device may include an identifier which is dedicated for synchronization purposes, and identifier which is also used for other purposes, or both.

The characteristic of the D2D communication device may include a quality of an internal clock of the D2D communication device, e.g., a frequency tolerance of the internal clock of the D2D communication device and/or a frequency drift of the internal clock of the D2D communication device.

Alternatively or in addition, the characteristic of the D2D communication device may include a number of D2D communication devices synchronized to the D2D communication device. Alternatively or in addition, the characteristic of the D2D communication device may include a number of D2D communication devices using the same synchronization reference as the D2D communication device. Alternatively or in addition, the characteristic of the D2D communication device may include a type of the D2D communication device. Examples of such type of D2D communication device are: a vehicle, a sensor, a power-limited device, or a reduced capabilities device, a relay device, a roadside unit, an industrial device, or a wearable device. Alternatively or in addition, the characteristic of the D2D communication device may include a capability of the D2D communication device, e.g., a capability of the D2D communication device to transmit the third synchronization signal. Alternatively or in addition, the characteristic of the D2D communication device may include a bandwidth available to the D2D communication device to transmit the third synchronization signal. Alternatively or in addition, the characteristic of the D2D communication device may include radio resources available to the D2D communication device to transmit the third synchronization signal. Alternatively or in addition, the characteristic of the D2D communication device may include a sequence type applicable by the D2D communication device to transmit the third synchronization signal. Alternatively or in addition, the characteristic of the D2D communication device may include a periodicity applicable by the D2D communication device to transmit the third synchronization signal. Alternatively or in addition, the characteristic of the D2D communication device may include a transmit power applicable by the D2D communication device to transmit the third synchronization signal.

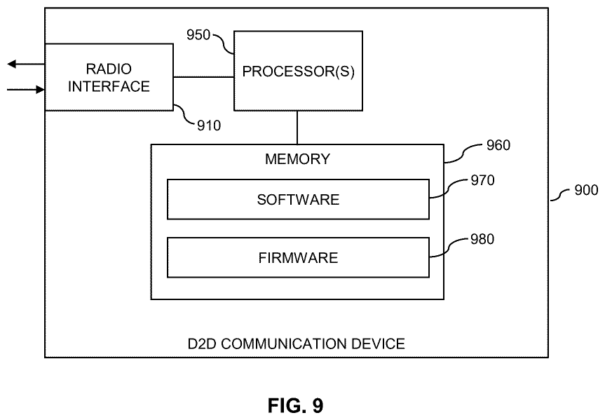

FIG. 9 illustrates a processor-based implementation of a D2D communication device 900 which may be used for implementing the above-described concepts. For example, the structures as illustrated in FIG. 9 may be used for implementing the concepts in any of the above-mentioned UEs 10.

As illustrated, the D2D communication device 900 includes one or more radio interfaces 910. The radio interface(s) 910 may for example be based on the NR technology or the LTE technology. However, other radio technologies, such as WLAN or Bluetooth, could be used as well. The radio interface(s) 910 may support D2D communication, e.g., using SL communication as specified for the NR technology or the LTE technology.

Further, the D2D communication device 900 may include one or more processors 950 coupled to the radio interface(s) 910 and a memory 960 coupled to the processor(s) 950. By way of example, the radio interface(s) 910, the processor(s) 950, and the memory 960 could be coupled by one or more internal bus systems of the D2D communication device 900. The memory 1560 may include a Read-Only-Memory (ROM), e.g., a flash ROM, a Random Access Memory (RAM), e.g., a Dynamic RAM (DRAM) or Static RAM (SRAM), a mass storage, e.g., a hard disk or solid state disk, or the like. As illustrated, the memory 960 may include software 970 and/or firmware 980. The memory 960 may include suitably configured program code to be executed by the processor(s) 950 so as to implement the above-described functionalities for controlling D2D communication, such as explained in connection with FIG. 7 or 8.

It is to be understood that the structures as illustrated in FIG. 9 are merely schematic and that the D2D communication device 900 may actually include further components which, for the sake of clarity, have not been illustrated, e.g., an internal clock, further interfaces or further processors. Also, it is to be understood that the memory 960 may include further program code for implementing known functionalities of a UE. According to some embodiments, also a computer program may be provided for implementing functionalities of the wireless communication device 900, e.g., in the form of a physical medium storing the program code and/or other data to be stored in the memory 960 or by making the program code available for download or by streaming.

As can be seen, the concepts as described above may be used for improving selection of synchronization references by D2D communication devices. A synchronization consensus can be achieved without adding excessive complexity to existing hierarchy schemes of synchronization references.

It is to be understood that the examples and embodiments as explained above are merely illustrative and susceptible to various modifications. For example, the illustrated concepts may be applied in connection with various kinds of radio technologies and D2D communication, without limitation the SL mode of the LTE technology or NR technology, e.g., in connection with WLAN technologies or other wireless ad-hoc network technologies. Further, the concepts may be applied with respect to various types of UEs. Further, the concepts may be applied in connection with various services supported by D2D communication. Moreover, it is to be understood that the above concepts may be implemented by using correspondingly designed software to be executed by one or more processors of an existing device or apparatus, or by using dedicated device hardware. Further, it should be noted that the illustrated apparatuses or devices may each be implemented as a single device or as a system of multiple interacting devices or modules.

1. A method of controlling device-to-device, D2D, communication, the method comprising:
a D2D communication device receiving a first synchronization signal from a first other D2D communication device;
the D2D communication device receiving a second synchronization signal from a second other D2D communication device;
if the first other D2D communication device and the second other D2D communication device have the same priority level for selection as a synchronization reference, the D2D communication device comparing a characteristic of the first other D2D communication device to a characteristic of the second other D2D communication device; and
based on the comparison, the D2D communication device selecting between synchronizing to the first synchronization signal and synchronizing to the second synchronization signal.

2. The method according to claim 1,
wherein the characteristic of the first other D2D communication device comprises a quality of an internal clock of the first other D2D communication device and the characteristic of the second other D2D communication device comprises a quality of an internal clock of the second other D2D communication device.

3. The method according to claim 2,
wherein the characteristic of the first other D2D communication device comprises a frequency tolerance of the internal clock of the first other D2D communication device and the characteristic of the second other D2D communication device comprises a frequency tolerance of the internal clock of the second other D2D communication device.

4. The method according to claim 2,
wherein the characteristic of the first other D2D communication device comprises a frequency drift of the internal clock of the first other D2D communication device and the characteristic of the second other D2D communication device comprises a frequency drift of the internal clock of the second other D2D communication device.

5-7. (canceled)

8. The method according to claim 1,
wherein the characteristic of the first other D2D communication device comprises a capability of the first other D2D communication device and the characteristic of the second other D2D communication device comprises a capability of the second other D2D communication device.

9. The method according to claim 8,
wherein the characteristic of the first other D2D communication device comprises a capability of the first other D2D communication device to transmit the first synchronization signal and the characteristic of the second other D2D communication device comprises a capability of the second other D2D communication device to transmit the second synchronization signal.

10. The method according to claim 8,
wherein the characteristic of the first other D2D communication device comprises a bandwidth available to the first other D2D communication device to transmit the first synchronization signal and the characteristic of the second other D2D communication device comprises a bandwidth available to the second other D2D communication device to transmit the second synchronization signal.

11. The method according to claim 8,
wherein the characteristic of the first other D2D communication device comprises radio resources available to the first other D2D communication device to transmit the first synchronization signal and the characteristic of the second other D2D communication device comprises radio resources available to the second other D2D communication device to transmit the second synchronization signal.

12. The method according to claim 8,
wherein the characteristic of the first other D2D communication device comprises a sequence type applicable by the first other D2D communication device to transmit the first synchronization signal and the characteristic of the second other D2D communication device comprises a sequence type applicable by the second other D2D communication device to transmit the second synchronization signal.

13. The method according to claim 8,
wherein the characteristic of the first other D2D communication device comprises a periodicity applicable by the first other D2D communication device to transmit the first synchronization signal and the characteristic of the second other D2D communication device comprises a periodicity applicable by the second other D2D communication device to transmit the second synchronization signal.

14. The method according to claim 8,
wherein the characteristic of the first other D2D communication device comprises a transmit power applicable by the first other D2D communication device to transmit the first synchronization signal and the characteristic of the second other D2D communication device comprises a transmit power applicable by the second other D2D communication device to transmit the second synchronization signal.

15-18. (canceled)

19. The method according to claim 1, comprising:
the D2D communication device determining the characteristic of the first other D2D communication device based on an identifier of the first other D2D communication device.

20. The method according to claim 19, comprising:
the D2D communication device determining the characteristic of the first other D2D communication device based on a mapping of the characteristic of the first other D2D communication device to the identifier of the first other D2D communication device.

21. The method according to claim 1, comprising:
the D2D communication device determining the characteristic of the second other D2D communication device based on an identifier of the second other D2D communication device.

22. The method according to claim 21, comprising:
the D2D communication device determining the characteristic of the second other D2D communication device based on a mapping of the characteristic of the second other D2D communication device to the identifier of the second other D2D communication device.

23. (canceled)

24. The method according to claim 1, comprising:
the D2D communication device transmitting a third synchronization signal for enabling synchronization of one or more further D2D communication devices using the D2D communication device as a synchronization reference, wherein the third synchronization signal indicates a characteristic of the D2D communication device.

25-27. (canceled)

28. The method according to claim 24,
wherein the characteristic of the D2D communication device is indicated by an identifier of the D2D communication device.

29-35. (canceled)

36. The method according to claim 24,
wherein the characteristic of the D2D communication device comprises a capability of the D2D communication device to transmit the third synchronization signal.

37-59. (canceled)

60. A D2D communication device, the D2D communication device being configured to:
receive a first synchronization signal from a first other D2D communication device;
receive a second synchronization signal from a second other D2D communication device;
if the first other D2D communication device and the second other D2D communication device have the same priority level for selection as a synchronization reference, compare a characteristic of the first other D2D communication device to a characteristic of the second other D2D communication device; and
based on the comparison, select between synchronizing to the first synchronization signal and synchronizing to the second synchronization signal.

61-65. (canceled)

66. A non-transitory computer-readable medium having stored thereon program code to be executed by at least one processor of a D2D communication device, whereby execution of the program code causes the D2D communication device to perform the method according to claim 1.
